(19) United States
(12) Patent Application Publication
(10) Pub. No.: US 2018/0339507 A1
(43) Pub. Date: Nov. 29, 2018

(54) LED PRINT CURING APPARATUS

(71) Applicant: GEW (EC) Limited, Crawley (GB)

(72) Inventors: Malcolm RAE, Crawley (GB); James HICKS, Crawley (GB)

(21) Appl. No.: 15/989,529

(22) Filed: May 25, 2018

(30) Foreign Application Priority Data
May 27, 2017 (GB) 1708521.8
Jan. 11, 2018 (GB) 1800435.8

(51) Int. Cl. B41F 23/04; F26B 3/28

(52) U.S. Cl. CPC B41F 23/0483; F26B 3/28; B41F 23/0486

(57) ABSTRACT

A print curing apparatus comprising an LED array comprising a body; the body comprising a mounting area with one or more LED modules mounted thereon; at least one heat sink; and one or more cooling modules, adjacent to the or each heat sink. The one or more cooling modules comprises at least one water-cooled holder comprising at least one fluid inlet channel and at last one fluid outlet channel therethrough; at least one heat pipe held substantially within the or each water-cooled holder, wherein the or each water-cooled holder is shaped to hold at least one heat pipe.

### CROSS-REFERENCE TO RELATED APPLICATIONS

This application is related to and claims the benefit of the filing date of UK patent applications Nos. GB1800435.8, filed Jan. 11, 2018, and GB1708521.8, filed May 27, 2017, the contents of which are incorporated by reference herein in their entirety.

### BACKGROUND OF THE INVENTION

### Field of the Invention

The present invention relates to an improved cooling system for an LED print curing apparatus.

### Description of the Related Art

The use of LED (light-emitting diode) arrays for print curing is becoming increasingly popular as an alternative to traditional mercury arc lamps. However, a limitation to the use of LEDs in existing print curing apparatus, which have a standard heat sink to carry heat away from the LEDs, is that the apparatus must be run at a reduced power to prevent overheating of the LEDs.

Standard heat sinks used with existing LED print curing apparatus are made of copper and it has been found that the heat transfer away from the LEDs is not sufficient to allow efficient cooling of the high-density LED components. The problem is particularly significant to LED print curing apparatus because the application requires high density packing of LEDs on a circuit board, which results in a very large amount of heat being generated in a small area. It is important that the LEDs do not overheat and become damaged or fail. Effective cooling is also needed to ensure that the curing effect is not sub-optimal, and that the substrate is not damaged by the excess heat created, or the output of the LEDs reduced by ineffective cooling. Existing heat sinks have been found to saturate quickly when no cooling is applied; for example, if a fault in the cooling system develops, such as a failure of the cooling fluid pumps, or a pipe leak. If there is a failure in the cooling system of existing systems then any temperature sensors cannot react quickly enough to turn off the LEDs before they are damaged, i.e., they “burn out”, which does not allow sufficient time for a fault to be detected before damage to the LEDs is caused. For example, a copper heat sink having a thickness of about 5 mm will saturate within 3-5 seconds before the LEDs are damaged, in the event of a cooling system failure.

A currently proposed solution to the problems caused by inefficient cooling of LEDs is to use air-cooling systems with finned heatsinks; however, such systems do not have sufficiently low total thermal resistance. Further air-cooled print curing apparatus currently used with LED technology includes devices having fans integrated into the lamphead. However, there are significant limitations to the cooling effect that can be achieved and so, such air-cooled devices can only be operated at lower power. Existing air-cooled devices are bulky and incompatible with being integrated into known housings for UV print curing apparatus. Thus, there remains a significant need to provide an improved cooling system for LED print curing apparatus.

Water cooling of conventional mercury arc print curing apparatus has required the use of multiple channels, each having a small diameter to increase the pressure of the water being used for cooling. Such water cooling apparatus requires the use of high pressure pumps in addition to filtering because the risk of blockages is significant.

US2011/222281 discloses a lighting module, including an array of light emitters, with a heat pipe having a flattened portion to which the array of light emitters is mounted. A single heat pipe passes along the array and through a cooling unit, which is positioned away from the heat sink/light emitter array.

The present invention sets out to provide an improved LED print curing apparatus, which alleviates the problems described above.

### SUMMARY OF THE INVENTION

In one aspect, the invention provides a print curing apparatus comprising an LED array, said LED array comprising a body, wherein the body comprises: a mounting area with one or more LED modules mounted thereon; at least one heat sink; and one or more cooling modules, adjacent to the or each heat sink, wherein said one or more cooling modules comprises: at least one water-cooled holder comprising at least one fluid inlet channel and at last one fluid outlet channel therethrough; and at least one heat pipe held substantially within the or each water-cooled holder, wherein the or each water-cooled holder is shaped to hold the or each heat pipe.

The cooling modules of the present invention offer a significant improvement in allowing the print curing apparatus to run for a period of time even without cooling; that is, in the event of a cooling system failure, the arrangement of the present invention allows the apparatus to run for a period before damage is caused to the LEDs. For example, it has been found that the improved print curing apparatus of the present invention can run for around 30 to 60 seconds with no cooling at all before damage is caused to the LEDs. It has been found that this period is sufficient to allow for the increased temperature to be detected; for example, by temperature sensors, and the apparatus to be turned off before damage is caused to the LEDs. This significantly reduces the maintenance requirements and environmental damage of unnecessary replacement of the LEDs, whilst also ensuring that the “down time” of the apparatus is significantly reduced.

Preferably, the or each cooling module comprises multiple heat pipes, wherein each heat pipe is held substantially within the or each water-cooled holder.

More preferably, the or each heat pipe is clamped within the or each water-cooled holder.

Preferably, the or each heat pipe is in direct thermal contact with a water-cooled holder.

The cooling modules of the present invention ensure optimum thermal contact between the heat pipe and the water-cooled holder. By clamping the or each heat pipe within the or each water-cooled holder, effective thermal transfer is achieved, whilst ensuring that the or each heat pipe is also correctly positioned.

Preferably, the water-cooled holder is a shaped extrusion having at least two channels; more preferably, the water-cooled holder is a shaped extrusion having at least six channels.

Preferably, the print curing apparatus comprises a plurality of water-cooled holders.

Preferably, the water-cooled holder comprises a plurality of cylindrical openings therethrough.

Preferably, the at least one fluid inlet and the at least one fluid outlet are separate from the or each heat pipe.

Preferably, the print curing apparatus comprises a plurality of LED modules, wherein each LED module is removably attached to three or more heat pipes.

The present invention is configured such that the water flow through the water-cooled holder is entirely separate from the heat pipes. Thus, the heat pipes can be removed from the apparatus for repair or maintenance without interfering with the water flow through the holder and without the system needing to be drained. Furthermore, any risk of leakage is significantly reduced. Potential damage to the heat pipes is avoided with a significant improvement in heat transfer. By keeping the fluid inlet/s and the fluid outlet/s separate from the heat pipes held by the water-cooled holder, the need for seals between the water/fluid flowing through the water-cooled holder and further components is eliminated. By eliminating the need for seals between components, particularly between the LED modules, ensures that the LED modules can be aligned continuously along the length of the print curing apparatus. This ensures that the curing effect along a substrate is uniform and uninterrupted.

Preferably, the or each water-cooled holder comprises three inlet channels and three outlet channels.

Preferably, each inlet channel and each outlet channel are an equal distance from the adjacent heat pipe.

Optionally, each channel is an elongate cuboidal shape.

Preferably, each channel comprises at least two finned walls.

Preferably, each channel has a cross-sectional width greater than about 2 mm.

The cooling effect of the water-cooled holder is improved by increasing the surface area for heat transfer to and from the walls of the water inlet and outlet channels; that is, by providing finned walls or projections from the walls, which protrude into the channel through which water flows.

Optionally, each channel is cylindrical; more preferably, each channel is cylindrical with a cross-sectional diameter greater than about 2 mm.

The use of heat pipes with the water-cooled holder of the present invention allows for the use of water channels having a greater diameter. Thus, the risk of blockages is significantly reduced whilst the cooling effect is much improved. The present invention reduces or eliminates the need for filtering of the water used for cooling.

Preferably, the inlet and/or the outlet channels are configured such that the flow of water therethrough is turbulent.

Preferably, the or each water-cooled holder is an extrusion shaped to hold the or each heat pipe in position.

Preferably, the or each water-cooled holder comprises two or more mating parts.

More preferably, the or each water-cooled holder comprises three or more mating parts.

It is understood that “mating” parts refers to component parts that, in use, mechanically connect and fit together.

Optionally, the or each water-cooled holder comprises an inner block and two outer blocks.

Preferably, each block has a length substantially identical to the length of the print curing apparatus.

Preferably, the print curing apparatus has a length of between about 10 cm and about 250 cm.

The “length” is understood to refer to the greatest of the three dimensions of the block and the print curing apparatus.

Preferably, each mating part comprises at least two semi-cylindrical recesses.

Preferably, each semi-cylindrical recess has a length that is substantially perpendicular to the length of the apparatus.

Preferably, the or each water-cooled holder comprises an inner block and two outer blocks. More preferably, the inner block mates with each of the outer blocks to form the water-cooled holder having cylindrical openings therethrough.

Preferably, each cylindrical opening has a length that is substantially perpendicular to the length of the apparatus.

Preferably, the wall of each cylindrical opening is in direct contact with the outer wall of the heat pipe held therein.

The orientation of the cylindrical openings of the present invention ensures that the heat pipes are positioned to maximise heat transfer away from the heat sink and the LED array. The evaporator section of the heat pipe is closest to the hottest part of the apparatus (LED array). The condenser section of the heat pipe is furthest from the LED array. This heat pipe arrangement ensures that heat is rapidly transferred away from the LEDs and from one end of the heat pipe to the other.

Preferably, the radius of the or each semi-cylindrical recess is less than the outer radius of the heat pipe to be received therein.

Preferably, the diameter of the or each cylindrical opening through the or each water-cooled holder is less than or equal to the outer diameter of the heat pipe to be held therein.

By “under-sizing” the heat-pipe receiving recesses, the present invention ensures that the heat pipes are securely held in place, whilst also ensuring that heat transfer is much improved. The heat pipe receiving recesses of the or each water-cooled holder primarily ensures thermal contact between the water-cooled holder and the heat pipe/s, whilst also locating the or each heat pipe in the correct position and orientation.

The arrangement of the present invention allows for the cooling modules, including the LED modules and the heat sink, to be built off-site and conveniently installed on site; for example, during an on-site repair without requiring on-site replacement of individual LED modules. The modular arrangement of the present invention allows for only partial replacement of some of the LED array/cooling modules without requiring replacement of all of the LEDs or cooling modules.

Preferably, the or each cooling module comprises three inlet channels and three outlet channels, wherein each channel is equidistant from an adjacent heat pipe.

Preferably, the or each inlet channel is closer to the adjacent heat sink than the or each outlet channel is to the adjacent heat sink.

It has been found that much improved cooling is achieved if the inlet channel, through which chilled water flows in use, is closer to the heat-generating components of the apparatus; that is, to the LED module/s and the heat sink/s.

Preferably, the or each inlet channel and the or each outlet channel are substantially parallel to the length of the print curing apparatus.

The present invention ensures that a large amount of heat is conducted quickly and efficiently away from each of the one or more LED modules in the LED array. The solution provided by the present invention allows the print curing apparatus to operate at full power, if required, because the conduction of heat away from the LEDs is much improved. The use of heat pipe technology in addition to water cooling with direct contact between each heat pipe and the water-cooled holder ensures that the heat transfer away from the LEDs is maximised with only a low water flow/chilling requirement. The present invention quickly and efficiently removes the significant amount of heat generated by the LED modules. It is also possible to achieve uniformity of cooling along the length of the apparatus.

The use of heat pipe technology together with water-cooling allows for an optimal print curing effect to be achieved, whilst the LEDs forming the LED array can be operated at full power along the full length of the print curing apparatus. By ensuring that the risk of overheating is minimised, if not eliminated, the LEDs last longer before it is necessary to replace them; whilst maintenance requirements are reduced. Thus, the present invention offers significant cost and environmental benefits.

The cooling system of the present invention is well-suited to cooling of LED modules, which are a linear source of radiation used for print curing. The arrangement of the heat pipes and the water-cooled holder/extrusion is carefully configured to be compatible with the small volume available in the housing of the print curing apparatus and the inclusion of the cooling system does not interfere with the substrate-facing (outer face) of the LED modules. Furthermore, the configuration allows for use with print curing apparatus of different lengths because of the modular arrangement of the LED modules and the cooling modules attached thereto.

Preferably, the water-cooled holder comprises a central block and two outer securing blocks. More preferably, the two outer securing blocks are configured to directly hold the or each heat pipe in position.

Preferably, the water-cooled holder comprises an elongate central block for supporting multiple heat pipes and two elongate outer securing blocks configured to hold the multiple heat pipes in position.

Preferably, the water flow through the or each water-cooled holder is separate from the or each heat pipe.

It is understood that “separate” means that the water flow through the or each water-cooled holder is apart from the heat pipe/s and is self-contained, such that there is no direct contact between the cooling fluid/water and the heat pipe/s.

The configuration of the or each extrusion also allows for easy repair and replacement of the heat pipes. Furthermore, by ensuring that the water flow is fully self-contained the flow rate and the amount of water flowing through the water-cooled holder can be increased to improve the efficiency of cooling. The cooling system of the present invention ensures that water is confined and does not contact the heat pipes, so that the potential risk of water leakage is much reduced. This also eliminates the need to protect the heat pipes; for example, by applying a coating to prevent corrosion, which then improves the heat transfer.

The present invention allows the print curing apparatus to have an improved tolerance to failure because of the much-improved heat transfer away from the LEDs, which ensures that, in the event of a cooling system failure, the present invention allows a time period during which sensors can detect an increase in temperature and switch off the LEDs before they are damaged by overheating, i.e. before they “burn out”. That is, the present invention has an improved tolerance before the heat sink is saturated, at which point heat cannot be transferred away from the LEDs causing the LEDs to overheat and “burn out”. This is because the present invention has a greater thermal mass into which heat can be transferred away from the LEDs, which comprises the heat sink, the heat pipes and water cooling. The cooling system of the present invention has the capability to remove heat from the LEDs for a longer period (30 to 60 seconds) before they are damaged, during which a fault can be identified and remedied. For example, a time period is available for a user to switch off the apparatus before damage to the LEDs occurs. Known heat sinks do not have a tolerance to failure of the cooling means and when cooling fails, LEDs will overheat almost immediately (about 3 to 5 seconds) and will need to be replaced before print curing can resume.

Optionally, the print curing apparatus further comprises at least one sensor for monitoring water flow.

Preferably, the pressure drop across the length of the print curing apparatus is negligible.

Preferably, the print curing apparatus further comprises one or more temperature sensors embedded adjacent to the or each heat sink.

It has been found to be advantageous to monitor the temperature of the heat sink in which the heat pipes sit with a probe, such as a PT100 sensor probe. By monitoring the temperature of the heat sink, the need to monitor flow is eliminated.

Preferably, the print curing apparatus comprises at least one heat sink that is highly polished to have a low surface roughness.

Within this specification, the term “substantially uniform” is understood to refer to a variation of less than about 20%; preferably, less than about 10%; preferably, less than about 5%; preferably, less than about 2%.

The present invention has been found to significantly improve cooling and so performance of the apparatus, because the cooling effect of the cooling system is substantially uniform along the length of the apparatus.

Preferably, the one or more heat pipes are positioned adjacent to the LED array.

Preferably, the or each heat pipe is substantially U-shaped.

The present invention reduces the number of bends in each heat pipe because it has been found that the efficiency of transfer is much improved by reducing the number of bends in the heat pipe.

The heat pipes of the present invention are configured to be positioned as close as possible to the LED array heat source to reduce the effect of any possible thermal boundary.

Optionally, the print curing apparatus comprises a plurality of LED modules, wherein each LED module is positioned adjacent to at least one heat pipe.

Optionally, the print curing apparatus comprises two LED modules for each heat pipe.

Preferably, the print curing apparatus comprises three heat pipes for each LED module.

Optionally, the print curing apparatus comprises a modular system comprising multiple heat sinks wherein each sink is arranged adjacent to three heat pipes.

In an optional embodiment of the present invention, the cooling system of the print curing apparatus comprises a modular system of LED modules and water-cooled heat pipe holders, which allows for efficient cooling across the multiple LED modules that form the array and allows for ease of maintenance should any one or more of the cooling modules and/or the LED modules require replacement. The present invention has been found to offer a significant improvement and can be used for a full range of sizes; that is, the present invention is suitable for the largest print heads where pressure loss across the print head has been found to be negligible.

It is understood that in alternative embodiments of the present invention a vapour chamber can be used rather than the heat pipe/s referred to. It is also understood that equivalent cooling fluids in addition to water can be passed through the fluid inlet and fluid outlet channel/s to achieve cooling of the water-cooled holder.

For the purposes of clarity and a concise description, features are described herein as part of the same or separate embodiments; however, it will be appreciated that the scope of the invention may include embodiments having combinations of all or some of the features described.

### DESCRIPTION OF THE SEVERAL VIEWS OF THE DRAWING

The invention will now be described by way of example with reference to the accompanying drawings, in which:—

FIG. 1 is a cross-sectional view through a cooling module of an LED print curing apparatus constructed according to the present invention;

FIG. 2 shows a perspective view from the side of a print curing apparatus, incorporating a plurality of cooling modules, in accordance with the present invention;

FIG. 3 shows an exploded perspective view of the print curing apparatus, showing the outer and central securing blocks of the water-cooled holder partially separated from the heat pipes;

FIG. 4 shows a cross-section through the water-cooled holder; and

FIG. 5 shows an exploded cross-sectional view through the outer and central blocks of the water-cooled holder with the heat pipes partially removed from the central block.

### DETAILED DESCRIPTION OF THE INVENTION

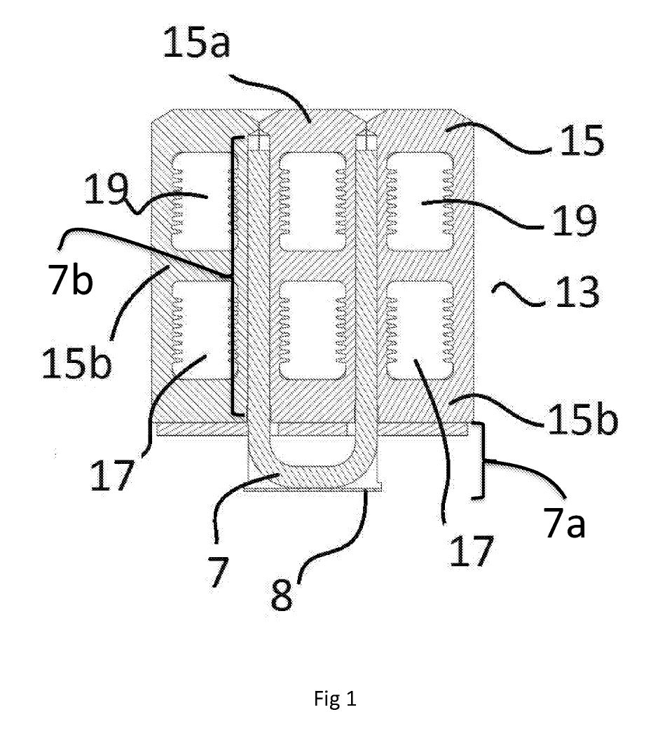

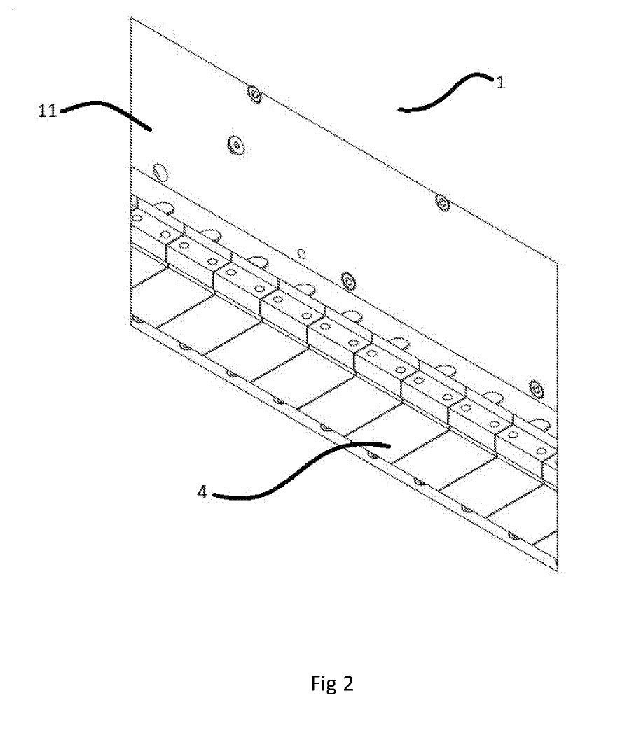

Referring to FIG. 1 and FIG. 2, the present invention relates to a print curing apparatus 1 comprising an array of LED modules 8 (not shown), wherein each LED module 8 is a unit containing one or more LEDs. In use, each LED is a radiation source for curing print or a coating on a substrate (not shown). It is understood that the LED modules 8 form a linear radiation source to direct radiation continually onto a substrate during curing. That is, there are no additional components between the LED modules 8 so that the radiation source is a continual, uninterrupted array along the apparatus. The LED modules 8 comprise boards that rest on a heat sink sandwiching a thermal compound therebetween. Electrical connections are made by terminals from the side to the top of the LED board.

In use, the LEDs are arranged to emit radiation from an outer, substrate-facing side of the LED modules 8 through a “curing window” onto a substrate (not shown) to be cured. In alternative embodiments of the present invention, the “curing window” comprises a lens or reflector. The print curing apparatus 1 is an elongate shape and can be fitted directly onto a machine, or is a slideable cassette which, in use, is slideable into a housing. When inserted into the housing, the LED modules form a solid radiation emitting face.

Referring to FIGS. 1, 2 and 3, in use, heat is transferred away from the inner face of the LED modules 8 by one or more cooling modules 13, wherein heat is transferred from heat pipes 7 into one or more water-cooled holders 15.

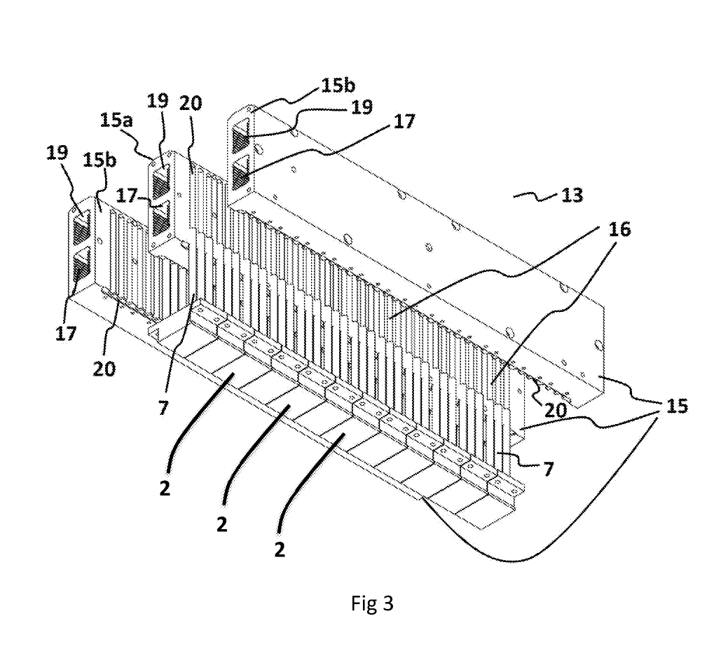

In a preferred embodiment shown in FIG. 3, the cooling module 13, comprising the heat pipes 7 fitted into a respective water-cooled holder 15, which is an elongate body along substantially the full length of the radiation emitting face of the LED modules 8. Each heat pipe 7 is directly held by the water-cooled holder 15 to improve thermal contact therebetween.

In an optional embodiment of the present invention, heat is transferred away from the LED modules by multiple cooling modules 13 (comprising heat pipes 7 sitting in water-cooled holders 15), which form an elongate body along substantially the full length of the radiation emitting face of the LED modules 8.

Referring to FIG. 3, the or each cooling module 13 comprises heat pipes 7, which fit into the water-cooled holder 15. In a preferred embodiment of the invention, the water-cooled holder 15 is an extrusion made from aluminium. As shown in FIG. 3, the water-cooled extrusion comprises a central, elongate block 15a and two outer, securing, elongate blocks 15b. In alternative embodiments of the present invention, the water-cooled extrusion 15 comprises two blocks into which the heat pipes 7 are fitted.

Each of the central block 15a and the outer, securing blocks 15b have semi-cylindrical recesses 20; that is, the recesses 20 have the shape of a longitudinal half of a cylinder. The central block 15a has multiple semi-cylindrical recesses 20 in each of the longer, outer-facing sides. Each of the outer, securing blocks 15b has multiple semi-cylindrical recesses 20 in one of its longer sides, which is facing inwardly. In use, the central block 15a mates with the two outer securing blocks 15b, whereby the multiple semi-cylindrical recesses 20 each hold a heat pipe 7 in place. The securing blocks 15a, 15b secure the heat pipes in a tight clamping arrangement, or by a “push-fit” connection. The semi-cylindrical recesses 20 are “undersized”—i.e. each have an inner radius that is less than the outer radius of the heat pipe 7. This ensures that each heat pipe 7 is firmly held in place and that the heat transfer is as efficient as possible from each heat pipe 7 to the surrounding water-cooled block/holder 15. Furthermore, the arrangement of the present invention allows for the cooling modules 13, including the LED modules 8 and heat sink 2, to be built off-site and conveniently installed on site; for example, during an on-site repair without requiring on-site replacement of individual LED modules.

In a preferred embodiment, as shown in FIG. 3, the cooling module 13 comprises a single elongate water-cooled holder 15 that comprises three securing blocks 15a, 15b along the length of the apparatus. Alternatively, the cooling module 13 comprises two securing blocks. To set up the cooling module 13, multiple modular heat sinks 2, each having three heat pipes 7 attached thereto, are each positioned along the block so that each heat pipe is received in a semi-cylindrical recess 20 in the central, elongate block 15a. The outer, securing blocks 15b are then brought into engagement with the central block 15a so that each heat pipe is also fitted within a respective semi-cylindrical recess 20 in an outer block 15b to clamp the heat pipes 7 in place. In an alternative embodiment of the present invention, the inner and outer securing blocks 15a, 15b are brought together and individual cooling modules are attached to the water-cooled holder 15 by inserting heat pipes into the cylindrical recesses of the water-cooled holder 15.

Referring to FIG. 3, the central block 15a and two outer securing blocks 15b are clamped or “push-fit” to form a removable pinch grip and hold the multiple heat pipes 7 in place, whilst allowing for removal of the heat pipes 7 for repair and replacement, as required. The holder 15 is secured in place around the heat pipes by screws. For known devices, the heat pipes 7 are spaced at increments of 2.5 cm for a range of lengths from 2.5 cm to 250 cm.

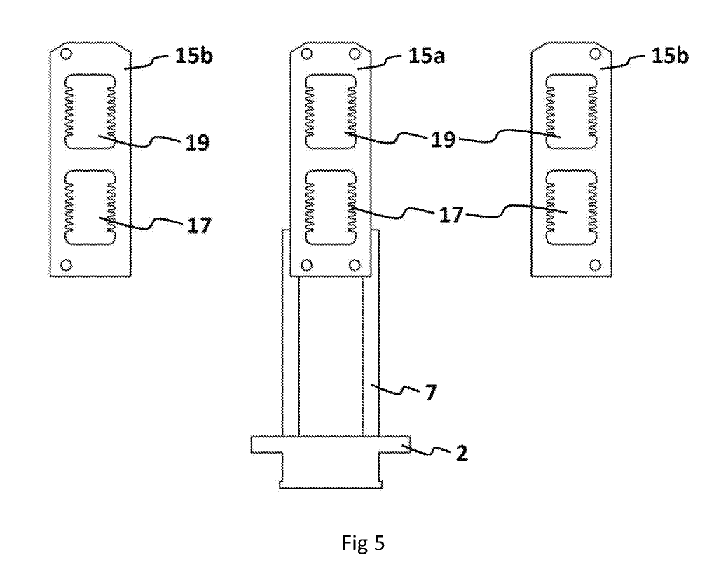

Referring to FIGS. 1, 3, 4 and 5, each of the three blocks 15a, 15b, which form the water-cooled holder 15, further comprises an inlet channel 17 and an outlet channel 19. The inlet and outlet channels 17, 19 are substantially parallel to the length of the apparatus 1. In a modular system, comprising multiple water-cooled blocks 15, the inlet and outlet channels 17, 19 of each block are connected to form channels 17, 19 that run along the full length of the apparatus 1.

Referring to the preferred embodiment of FIG. 3, in use, a source of cooled water is fed into the inlet channels 17, such that cooled water flows along the length of the apparatus 1 to carry heat away from the water-cooled block 15, which is carrying heat away from the heat pipes 7. In use, heated water is carried away from the apparatus through outlet channels 19. The heated water output from the apparatus 1 is cooled before it is re-fed back to the inlet channels 17. The water flowing through the water-cooled holder 15 does not come into direct contact with the heat pipes 7, the heat sink 2, or the LED modules 8.

Referring to FIGS. 1, 2 and 3, the heat pipes 7 of the present invention use known heat pipe technology to take up heat generated by the LED modules 8. In use, when the apparatus 1 is switched on and the LEDs are radiating to cure a substrate, heat generated by the LEDs is transferred away from the rear, inner face of each LED module 8 to a copper heat sink 2. Heat is carried away from the LEDs by the heat pipe/s 7 and is then carried away from the heat pipes 7 by the respective water-cooled holder 15. On heating, the liquid held within the core of the heat pipe 7 is vaporised and the heat is carried away before the liquid re-condenses and the wick transports the liquid back to the base of the heat pipe 7. Heat is rapidly transferred from the LED modules to the heat pipes 7 and to the water-cooled holder 15.

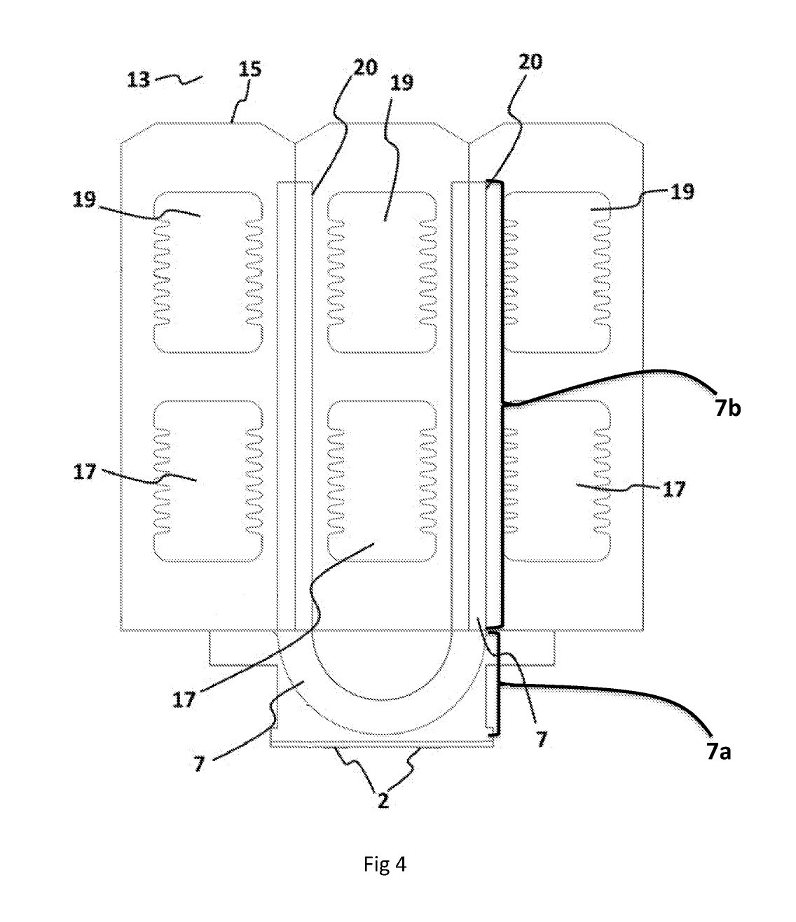

The heat pipes 7 transfer heat away from the rear, inner face of the LED modules 8 over the length of each of the heat pipes 7 to the water-cooled holder 15. The arrangement of multiple heat pipes 7, wherein each heat pipe 7 is substantially U-shaped has been found to be particularly advantageous in improving the efficiency of heat transfer away from the LED array. Referring to FIG. 4, the U-shaped heat pipes 7 of the present invention each have a curved base section adjacent to the LED modules 8 and the upstanding sections of the heat pipes 7 are substantially perpendicular to the length of the apparatus 1.

The embodiment described above comprises water inlet channels 17 that are adjacent to the evaporator section 7a of the heat pipes, which are closest to the heat-generating LED modules 8 and the heat sink 2. The water inlet channels 17 do not directly contact the heat pipe 7, the LED modules 8, or the heat sink 2. The water outlet channels 19 are adjacent to the condenser section 7b of the heat pipes, which are furthest from the LED modules 8. It has been found that the efficiency of cooling is also improved by having two water-cooled inlet channels 17 adjacent to each of the upstanding sections of the heat pipe 7, such that each heat pipe 7 is effectively cooled around most of its outer surface.

The present invention is arranged such that the coldest areas of the water-cooled holder 15, which are adjacent to the water inlet channel 17, are near to the hottest part of the heat pipe 7 to maximise the rate of condensation and increase the rate of heat flow away from the LEDs 8 to be carried away by the water. There is a thermal gradient along the condenser section 7b, from the coolest area furthest from the LED modules 8 to the hottest area closest to the LED modules 8.

The print curing apparatus 1 comprises a plurality of LED modules 8, wherein each of the LED modules 8 is adjacent to three heat pipes 7. The multiple heat pipes 7 are clamped in position by the three elongate blocks 15a, 15b of the water-cooled holder 15. In alternative embodiments of the present invention, it is envisaged that the water-cooled holder 15 is also modular; comprising multiple central elongate blocks 15a and multiple outer securing blocks 15b. A modular water-cooled holder 15 is secured together by securing means, such as flanges and O-rings.

Referring to FIGS. 3, 4 and 5, when the water-cooled holder 15 is positioned around the heat pipes 7, the heat pipes 7 are held within the cylindrical recesses 20 formed by the mating parts 15a, 15b of the water-cooled holder 15. The water-cooled holder 15 when fitted around the heat pipes 7 further comprises three water inlet channels 17, which are formed in the lower part of the holder 15 and are substantially parallel to the longitudinal axis of the apparatus 1. Three return/outlet water channels 19 are formed in the upper part of the holder 15 and are also substantially parallel to the longitudinal axis of the apparatus 1.

In alternative embodiments, there may be two or more inlet and outlet channels. It is understood that the “lower part” of the holder 15 is the part closest to the LED modules 8 and heat sink 2; the “upper part” of the holder 15 is the part furthest from the LED modules 8 and the heat sink 2; and the “longitudinal axis” of the apparatus 1 is the axis parallel to longest length of the apparatus 11. In a preferred embodiment of the present invention, the water-cooled holder 15 forms a slideable cassette, which is slideably inserted into and removable from the print curing apparatus 1 in a direction parallel to the longest length of the apparatus. In alternative embodiments of the present invention, the water-cooled holder 15 is a fixed component of the print curing apparatus 1 and is not a slideable cassette.

In alternative embodiments of the present invention, the water-cooled holder 15 may comprise two water-flow channels, through which water flows. In this embodiment, water is supplied at one end of both water-flow channels and is output at the opposing end of each channel.

As shown in FIGS. 1, 3, 4, and 5, in a preferred embodiment of the present invention, each channel 17, 19 is an elongate cuboidal shape and comprises two opposing, finned walls. The cooling effect of the water-cooled holder 15 is improved by increasing the surface area for heat transfer to and from the walls of the water inlet and outlet channels 17, 19; that is, by providing finned walls or projections from the walls which protrude into the channel 17, 19 through which water flows.

Each inlet and outlet channel 17, 19 is between a first end plate and a second end plate. The first end plate is connected to a source of chilled water (not shown) and an outlet for heated water (not shown).

In use, cold water enters the apparatus 1 through inlets in the first end plate and flows along each of the three inlet channels 17 through the lower part of the water-cooled holder 15. The chilled water is heated by the heat generated by the LED modules 8, which is carried away from the LED modules 8 by the heat pipes 7, with the heat pipes 7 rapidly drawing heat away from the LED modules 8 and the heat sink 2. When the cold water has passed along the full length of the inlet channels 17 and so, along the full length of the apparatus 11 to the second end plate, the heated water returns through the three return channels 19 and is removed from the system through outlets in the first end plate.

Referring to FIG. 3, to access the heat pipes 7 for maintenance or repair, the screws securing the water-cooled holder 15 around the heat pipes 7 are removed. The connection between the outer securing blocks 15b can then be separated from the central block 15a. The water flow through the water-cooled holder 15 can easily be disconnected and there is no risk of disturbing water flow when accessing the heat pipes 7, because water flow is separated and fully contained within the water-cooled holder 15.

Within this specification, the term “about” means plus or minus 20%; more preferably, plus or minus 10%; even more preferably, plus or minus 5%; most preferably, plus or minus 2%.

The above described embodiment has been given by way of example only, and the skilled reader will naturally appreciate that many variations could be made thereto without departing from the scope of the claims.

We claim:

1. A print curing apparatus comprising:
an LED array comprising a body, the body comprising: a mounting area with one or more LED modules mounted thereon; at least one heat sink; and one or more cooling modules, adjacent to the at least one heat sink,
wherein the one or more cooling modules comprise at least one water-cooled holder comprising at least one fluid inlet channel and at least one fluid outlet channel therethrough; and at least one heat pipe held substantially within the at least one water-cooled holder, wherein each of the at least one water-cooled holder is shaped to hold at least one of the at least one heat pipes.

2. The print curing apparatus according to claim 1 wherein the at least one water-cooled holder comprises a plurality of cylindrical openings therethrough.

3. The print curing apparatus according to claim 1, wherein the at least one fluid inlet channel and the at least one fluid outlet channel are separate from the at least one heat pipe.

4. The print curing apparatus according to claim 1, wherein each of the at least one heat pipe is clamped within its respective one of the at least one water-cooled holders.

5. The print curing apparatus according to claim 1, further comprising a plurality of LED modules, wherein each LED module is removably attached to three or more heat pipes.

6. The print curing apparatus according to claim 4, wherein the water-cooled holder is a shaped extrusion comprising at least two fluid inlet channels and at least two fluid outlet channels therethrough, at least four channels therethrough, or at least two fluid inlet channels and at least two fluid outlet channels.

7. The print curing apparatus according to claim 1, wherein each of the at least one inlet channel and each of the at least one outlet channel is an equal distance from the adjacent heat pipe, wherein each of the at least one inlet channel and each of the at least one outlet channel has an elongate cuboidal shape, wherein each of the at least one inlet channel and each of the at least one outlet channel has at least two finned walls, or wherein each of the at least one inlet channel and each of the at least one outlet channel has a cross-sectional width greater than about 2 mm.

8. The print curing apparatus according to claim 1, wherein the at least one inlet channel and the at least one outlet channel are configured such that a flow of water therethrough is turbulent.

9. The print curing apparatus according to claim 1, wherein the at least one water-cooled holder is block shaped for holding the at least one heat pipe in position, and wherein the at least one water-cooled holder comprising three or more mating parts.

10. The print curing apparatus according to claim 1, wherein the at least one inlet channel is closer to the heat sink than the one or more outlet channel is to the heat sink.

11. The print curing apparatus according to claim 1, wherein a pressure drop across the length of the print curing apparatus is negligible.

12. The print curing apparatus according to claim 1, wherein the at least one water-cooled holder comprises an inner block and two outer blocks, and wherein each block has a length substantially identical to the length of the print curing apparatus.

13. The print curing apparatus according to claim 12, wherein each of the inner and two outer blocks comprises at least two semi-cylindrical recesses each having a length that is substantially perpendicular to the length of the apparatus, wherein the inner block mates with each of the outer blocks to form the water-cooled holder having cylindrical openings therethrough, wherein the radius of each semi-cylindrical recess is equal to or less than the radius of the outer wall of a heat pipe held therein, or wherein the diameter of each cylindrical opening is equal to or less that the diameter of the outer wall of the heat pipe held therein.

14. The print curing apparatus according to claim 1, further comprising a plurality of LED modules, wherein each LED module is positioned adjacent to at least one cooling module, and wherein each cooling module comprises three heat pipes for each LED module.
